(19) United States
(12) Patent Application Publication
(10) Pub. No.: US 2015/0001764 A1
(43) Pub. Date: Jan. 1, 2015

(54) MOLD FOR CONSTRUCTION STRUCTURE AND METHOD FOR MANUFACTURING CONSTRUCTION STRUCTURE USING SAME

(71) Applicant: Jang Hoon Kim, Suwon-shi (KR)

(72) Inventor: Jang Hoon Kim, Suwon-shi (KR)

(73) Assignee: AJOU UNIVERSITY INDUSTRY-ACADEMIC COOPERATION FOUNDATION, Suwon, Gyeonggi-do (KR)

(21) Appl. No.: 14/378,331

(22) PCT Filed: Jul. 5, 2012
(86) PCT No.: PCT/KR2012/005345

§ 371 Date: Aug. 13, 2014

(30) Foreign Application Priority Data
Feb. 14, 2012 (KR) 10-2012-0014818

(51) Int. Cl. B28B 7/24; B28B 1/24; B28B 17/00

(52) U.S. Cl. CPC B28B 7/241; B28B 17/009; B28B 1/24
USPC 264/328.16; 249/125; 264/328.1

(57) ABSTRACT

Disclosed is a mold for a construction structure which includes a plurality of hollow mold units arranged in a predetermined 3D pattern; a plurality of connecting units detachably connecting the mold units and communicating the mold units; and an outside wall fixing and supporting the outermost mold units in the mold units.

### TECHNICAL FIELD

The present invention relates to a mold for a construction structure and a method for manufacturing a construction structure using the same, and more particularly to a mold for a construction structure that includes a plurality of hollow unit cells arranged in a 3D pattern and can be used for high-rise buildings or large structures, and a method for manufacturing a construction structure using the mold.

### BACKGROUND ART

In general, materials that are used for constructing high-rise buildings or large structures such as a large-capacity wind power generator tower increase the weight of structures because they are large in cross-section and heavy, so they increase the size of bases and cause a large amount of time and cost in foundation works.

Further, as the materials become more massive, cracks by external forces such as a shock or fatigue or early partial damage easily develops to the entire cross-sections due to continuity of the materials, so the possibility of causing fracture such that the resistance of the materials is reduced or lost increases.

Further, for an element of the precast concrete, it is economical to reduce the number of all of materials by increasing the size of unit materials as large as possible, but in this case, crane capacity and transportation are limited by an increase in weight, thus increasing distribution costs.

As a method for solving those problems, a construction structure including a hollow structure with a plurality of hollow unit cells arranged in a 3D pattern can be considered and a technology about the construction structure including a hollow structure was described in Korean Patent Application No. 2011-0108067 by the applicant.

In order to manufacture a hollow structure for the construction structure described above, however, it is required to prepare a 3D mold corresponding to the hollow structure, so it takes a long time to prepare frames and the entire construction period may increase, and there is a limit that it is difficult to manufacture construction structures including the hollow structure in large quantities especially through systematization.

### DISCLOSURE

### Technical Problem

The present invention has been made in an effort to solve the problems and an object of the present invention is to provide a mold for a construction structure which can reduce the entire construction period and can be systemized especially to be able to achieve mass production by easily manufacturing a construction structure including a hollow structure with a plurality of unit cells arranged in a 3D pattern, and a method for manufacturing a construction structure using the mold.

### Technical Solution

According to an aspect of the present invention for achieving the objects, there is provided a mold for a construction structure, which includes: a plurality of hollow mold units arranged in a predetermined 3D pattern; a plurality of connecting units detachably connecting the mold units and communicating the mold units; and an outside wall fixing and supporting the outermost mold units in the mold units.

According to another aspect of the present invention, there is provided a method for manufacturing a construction structure, which includes: preparing the mold for a construction structure; injecting a material corresponding to the purpose in between a plurality of mold units in the mold for a construction structure; curing the material injected in between the mold units; and achieving a construction structure with a plurality of hollow mold units therein by separating the outside wall.

### Advantageous Effects

According to the mold for a construction structure and the method of manufacturing a construction structure using the mold of the present invention, the following effects are achieved.

First, since it is possible to achieve a mold corresponding to the 3D pattern of a hollow structure of construction structure to be manufactured, by extending the entire shape by systematically combining a plurality of mold units, it is possible to remarkably reduce the entire construction period by reducing the time taken for preparing frames in the related art.

Second, it is possible to provide the base of systematization allowing mass production of the hollow structure of the construction structure.

Third, by injecting and circulating fluid heated or cooled at complementary temperature against the external temperature conditions when manufacturing the hollow structure for a construction structure, it is possible to reduce the entire construction period by reducing the time for curing even under extreme external temperature conditions (North Pole, South Pole, deserts, and the like), and accordingly, it is possible to reduce the manufacturing cost.

Fourth, when precast concrete elements are used by means of the mold for a construction structure of the present invention, it is possible to largely reduce the necessary cost for the incidental facilities such as necessary equipment.

### DESCRIPTION OF DRAWINGS

FIG. 1 is a perspective view illustrating a mold for a construction structure according to an embodiment of the present invention.

FIG. 2 is a plan cross-sectional view of the mold for a construction structure illustrated in FIG. 1.

FIG. 3 is a perspective view illustrating a mold unit of the mold for a construction structure illustrated in FIG. 1.

FIGS. 4 and 5 are a perspective view and a plan cross-sectional view illustrating another embodiment of the mold unit of the mold for a construction structure illustrated in FIG. 1 and illustrating the arrangement of the mold units, respectively.

FIGS. 6 and 7 are an exploded cross-sectional view and an assembled cross-sectional view illustrating a connecting unit of the mold for a construction structure illustrated in FIG. 1, respectively.

FIG. 8 is an exploded cross-sectional view illustrating another embodiment of the connecting unit illustrated in FIGS. 6 and 7.

FIGS. 9 and 10 are an exploded cross-sectional view and an assembled cross-sectional view illustrating a coupling unit of the mold for a construction structure illustrated in FIG. 1, respectively.

FIG. 11 is a flowchart illustrating a method for manufacturing a construction structure using the mold for a construction structure illustrated in FIG. 1.

FIGS. 12 and 13 are a perspective view and a cross-sectional view of a construction structure manufactured in accordance with the method for manufacturing a construction structure illustrated in FIG. 11.

[Description of Main Reference Numerals of Drawings]

| | |
|---|---|
| 1: Construction structure | 10: Mold |
| 100, 100a: Mold unit | 200, 200a: Connecting unit |
| 210: Extension | 220: Coupler |
| 300: Outside wall | 400: Coupling unit |
| 410: Fixed block | 420: Coupler |
| 500: Bolt | |

### BEST MODE

An aspect of the present invention provides a mold for a construction structure, which includes: a plurality of hollow mold units arranged in a predetermined 3D pattern; a plurality of connecting units detachably connecting the mold units and communicating the mold units; and an outside wall fixing and supporting the outermost mold units in the mold units.

The mold units may have at least one cross-section selected from a group of a circle, an ellipse, and polygon, and a closed shape with curved lines and straight lines. For example, the mold units may have a trapezoidal cross-section and may be arranged along curved lines in the entire shape.

The mold units may be made of a soft material having flexibility. For example, wherein the mold units may be made of one selected from a group of reinforcing rubber, plastic, and vinyl.

The connecting unit each may have at least a pair of extensions that communicates with a pair of adjacent mold units and extends outward to face each other, and at least coupler that detachably connects the pair of extensions such that the extensions communicate with each other. On the other hand, the pair of extensions and the coupler may be thread-fastened to each other. The coupler may have first and second couplers thread-fastened to the pair of extensions, respectively, and a bridge connecting the first and second couplers such that the first and second couplers can rotate.

The mold for a construction structure may further include a plurality of coupling units fixing the outermost mold units to the outside wall. The coupling units each may include: a fixed block that is fixed to the outside wall to face the extension of the outermost mold units; and a coupler that detachably combines the extension and the fixed block which face each other. The extension and the coupler may be thread-fastened. The mold for a construction structure may further include at least one bolt fixing the fixed block to the outside wall by being thread-fastened to the fixed block through the outside wall.

Another aspect of the present invention provides a method for manufacturing a construction structure, which includes: preparing the mold for a construction structure; injecting a material corresponding to a purpose in between a plurality of mold units in the mold for a construction structure; curing the material injected in between the mold units; and achieving a construction structure with a plurality of hollow mold units therein by separating the outside wall.

The curing of the injected material may further include injecting and circulating fluid in the mold units. The circulating fluid may be heated or cooled to have complementary temperature against the external temperature.

### MODE FOR INVENTION

Hereinafter, exemplary embodiments of the present invention are described in detail with reference to the accompanying drawings.

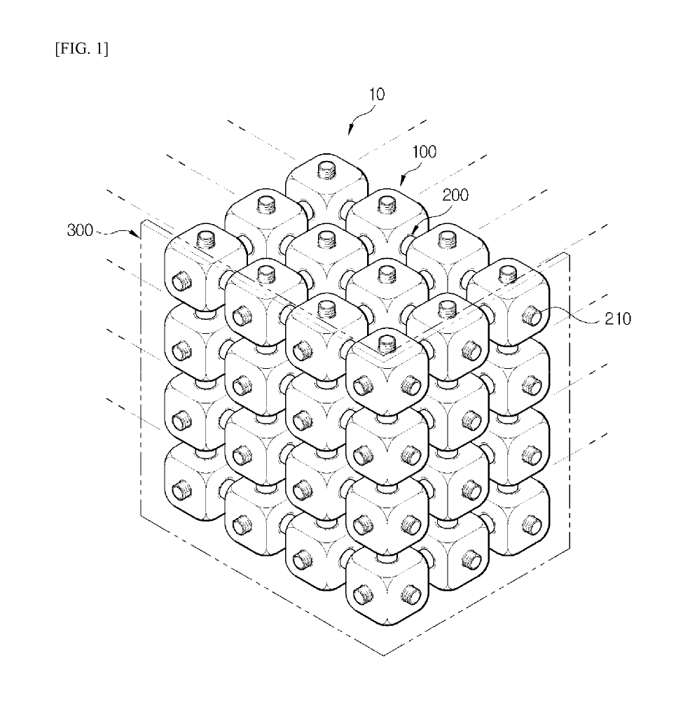

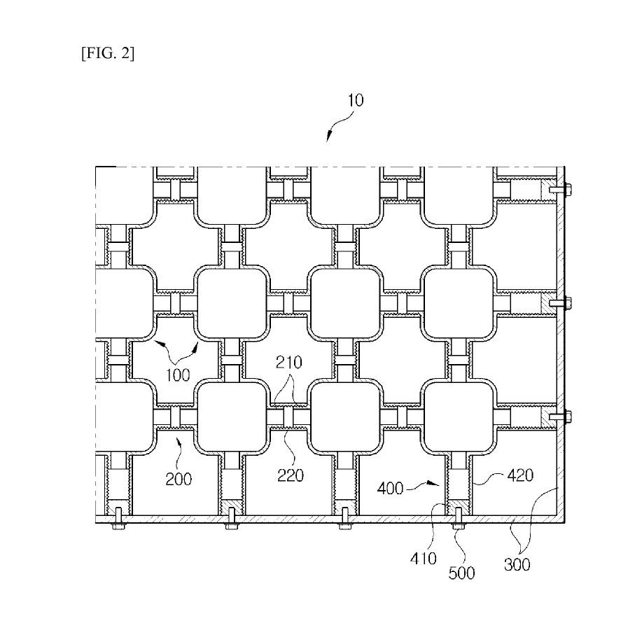

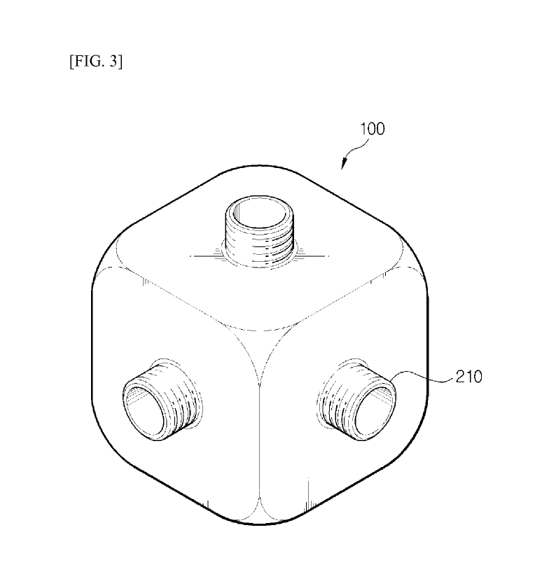

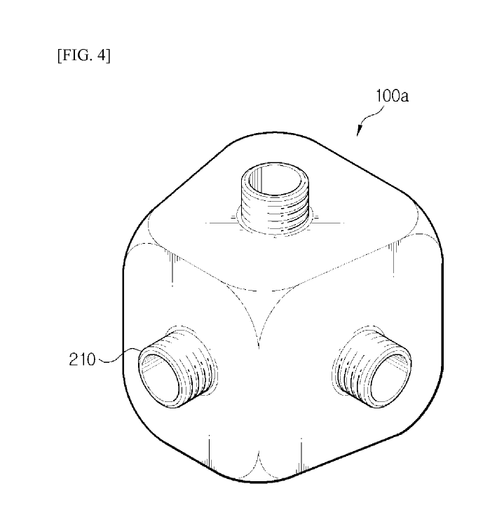

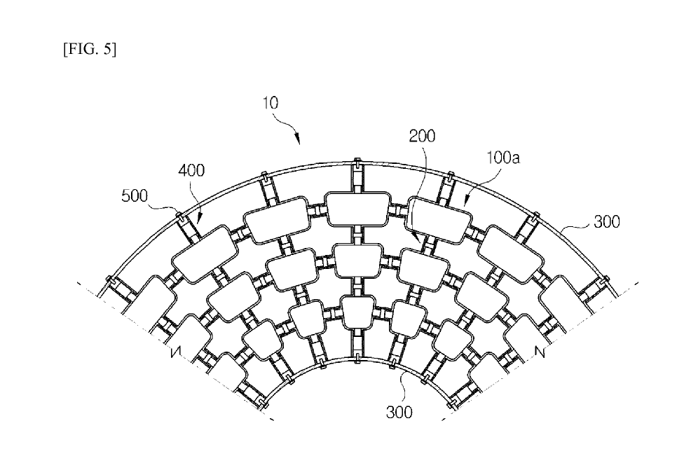

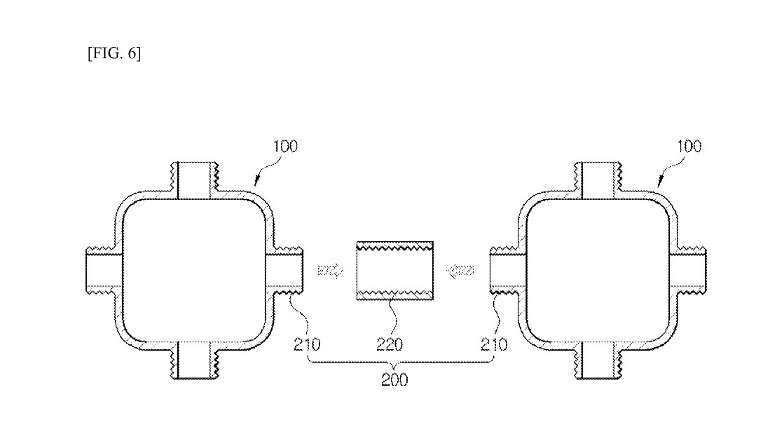

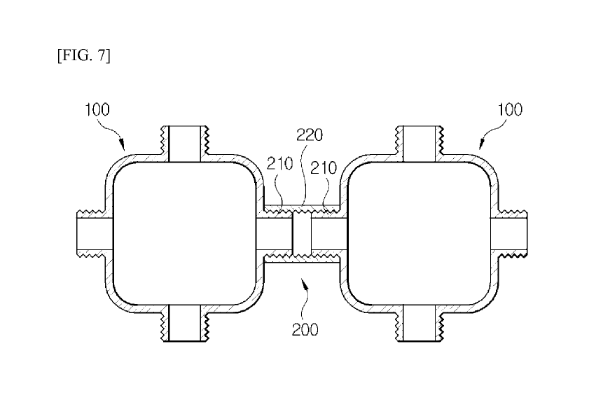

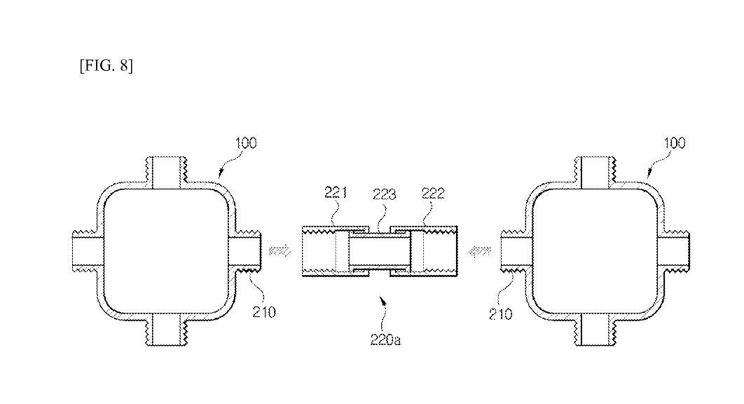

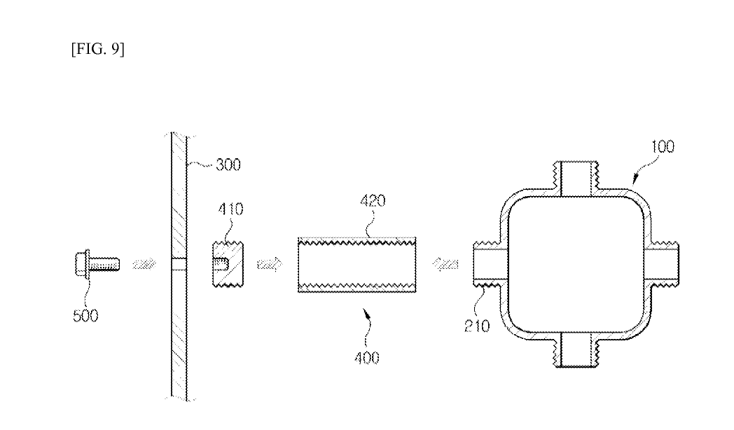

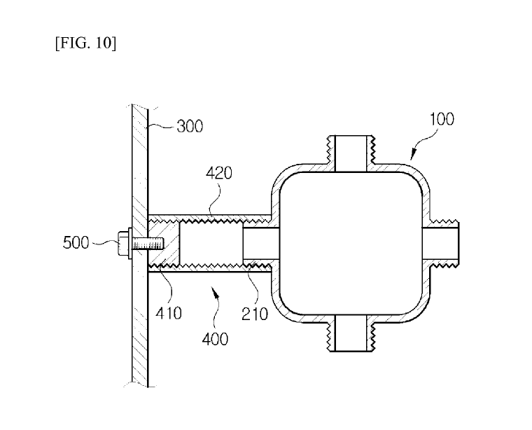

FIG. 1 is a perspective view illustrating a mold for a construction structure according to an embodiment of the present invention, FIG. 2 is a plan cross-sectional view of the mold for a construction structure illustrated in FIG. 1, FIG. 3 is a perspective view illustrating a mold unit of the mold for a construction structure illustrated in FIG. 1, FIGS. 4 and 5 are a perspective view and a plan cross-sectional view illustrating another embodiment of the mold unit of the mold for a construction structure illustrated in FIG. 1 and illustrating the arrangement of the mold units, respectively, FIGS. 6 and 7 are an exploded cross-sectional view and an assembled cross-sectional view illustrating a connecting unit of the mold for a construction structure illustrated in FIG. 1, respectively, FIG. 8 is an exploded cross-sectional view illustrating another embodiment of the connecting unit illustrated in FIGS. 6 and 7, and FIGS. 9 and 10 are an exploded cross-sectional view and an assembled cross-sectional view illustrating a coupling unit of the mold for a construction structure illustrated in FIG. 1, respectively.

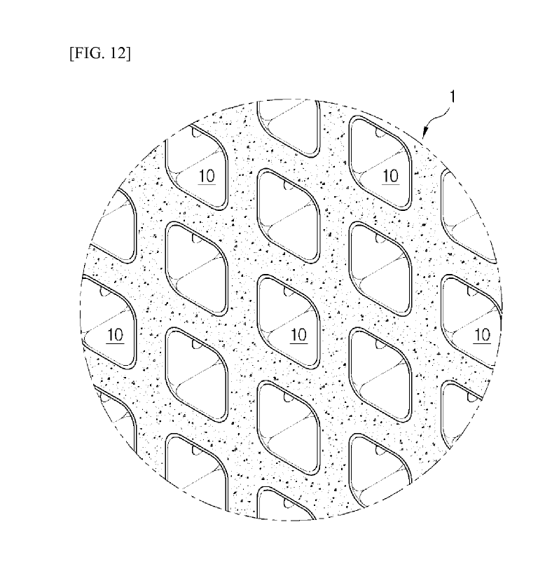

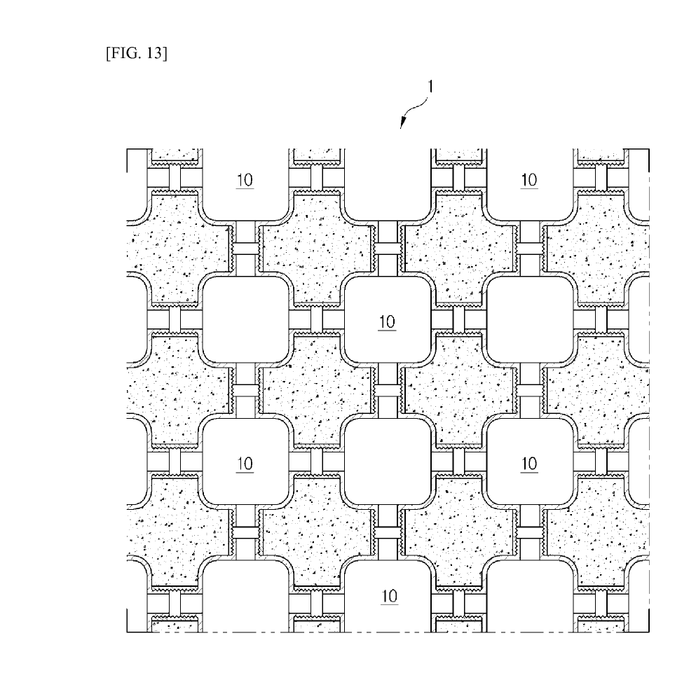

Referring to the figures, a mold 10 for a construction structure (hereafter, referred to as a ‘mold’) according to an embodiment of the present invention is a part for manufacturing a construction structure 1 (see FIGS. 12 and 13) that includes a plurality of hollow unit cells arranged in a 3D pattern and can be used for high-rise buildings or large structures. To this end, the mold 10 includes a plurality of mold units 100, a plurality of connecting units 200, and an outside wall 300.

The mold units 100 are hollow and arranged in a predetermined 3D pattern. That is, the mold units 100 are arranged longitudinally, vertically, and transversely, having a predetermined 3D shape. However, in FIGS. 1 and 2, although the 3D pattern formed by the arrangement of the mold units 100 is a matrix-shaped hexahedron, it is only an example and they may be arranged in various 3D patterns in accordance with the use purpose of the construction structure 1 to be manufactured. Accordingly, the scope of right of the present invention should not be unreasonably construed as being limited by the 3D pattern illustrated in the figures accompanied by this specification. For example, they may be arranged in 3D polyhedron patterns such as an octahedron and a dodecahedron or 3D patterns with curved surfaces.

Further, the mold unit 100 may be made of soft materials having flexibility. However, the mold units 100 should be soft such that they do not influence the strength of the cell inner wall of the construction structure 1 to be manufactured and should also be strong such that they can resist work loads, which are applied in the process of manufacturing the construction structure 10 to be manufactured by the mold units 100, without large deformation. For the mold units 100, reinforced rubber, plastic, or vinyl may be used, but the present invention is not limited thereto.

On the other hand, although the mold units 100 of the mold 10 forming a 3D pattern illustrated in FIGS. 1 and 3 each have a rectangular cross-section, but it is only an example and they may be formed in various shapes. For example, though not illustrated in the figures, the mold units 100 may have at least one of the cross-sections selected from a group of a circle, an ellipse, a polygon, and a closed shape with curves and straight lines.

Further, as illustrated in FIG. 4, the mold unit 100a may have a trapezoidal cross-section. An advantage of the mold units 100a having a trapezoidal cross-section is that they can be arranged in the entire shape of curved lines, as illustrated in FIG. 5. That is, when the construction structure 1 to be manufactured has a curved surface, it is possible to manufacture a mold 10, using the mold units 100a having a trapezoidal cross-section, and to manufacture the construction structure 1 with a curved surface, using the mold 10. Further, as in the construction structure 1 with curved surfaces and straight lines, even if 3D shapes over 2D are combined, it is possible to cope with the shape of the desired construction structure 1 by means of complex arrangements of the mold units 100 and 100a having different shapes. Further, though not illustrated, the mold units 100 and 100a may be manufactured with a predetermined curvature, if necessary.

The connecting units 200 detachably connect the mold units 100. The connecting units 200 connect the mold units 100 such that the insides of the mold units 100 communicate with each other. To this end, the connecting units 200 each may include at least a pair of extensions 210 and at least one coupler 220, as illustrated in FIGS. 6 and 7.

The pair of extensions 210 extends outward from a pair of adjacent mold units 100 to face each other. The pair of extensions 210 extends to communicate with the insides of the mold units 100. However, although the extensions 210 are formed integrally with the mold units 100 in the figures, it is only an example and separate extensions 210 may be combined with the mold units 100. Further, the couplers 220 detachably connect the pairs of extensions 210 facing each other such that the insides of the extensions communicate with each other. To this end, the pair of extensions 210 and the couplers 220 may be thread-fastened.

In order to combine the pair of extensions 210 and the coupler 220, it is preferable to fasten the coupler 220 simultaneously to the pair of extensions 210 facing each other, by turning the coupler 220 in one direction. To this end, the directions of the threads formed on two extensions 210 symmetrically positioned on one mold unit 200 should be opposite to each other. Compared with a dice, in one mold unit 200, the extensions 210 protruding at the positions corresponding to the numbers on each dice are formed such that the directions of their threads are alternately changed in accordance with the order of the numbers. For example, when the thread on the extension 210 corresponding to number 1 is formed clockwise, the thread on the extension corresponding to number 2 is formed counterclockwise, the thread on the extension corresponding to number 3 is formed clockwise, the thread on the extension corresponding to number 4 is formed counterclockwise, the thread on the extension corresponding to number 5 is formed clockwise, and the thread on the extension corresponding to number 6 is formed counterclockwise. Further, the threads on the couplers 220 should be formed opposite to each other so that they can correspond to the extensions 210 facing each other. In this case, it is preferable that signs such as a color, a mark, or a symbol exhibiting the corresponding thread direction are provided on the extensions 210 and the couplers 220 in order to easily match the pairs of extensions 210 and the couplers 220. According to the combination manner of the pair of extensions 210 and the couplers 220, it is possible to easily thread-fasten the couplers 220 to the extensions 210 facing each other by turning only the couplers 220 without turning the mold units 100, so assembling is more convenient.

Alternately, as illustrated in FIG. 8, the coupler 220a may have first and second couplers 221 and 222 and a bridge 223. The first and second couplers 221 and 222 are thread-fastened to the pair of extensions 210, respectively. The bridge 223 connects the first and second couplers 221 and 222 such that they can rotate. The coupler 220a provides the advantage that it is not required to consider the direction of a spiral to be formed and to turn the mold unit 100. That is, since it is possible to more easily thread-fasten the first and second couplers 221 and 222 with the pair of extensions 210 by turning the couplers, improvement of assembling can be expected.

The outside wall 300 fixes and supports the outermost mold units 100 in the mold units 100. To this end, the mold 10 may further include a plurality of coupling units 400 that fixes and combines the outer mold units 100 and the outside wall 300.

The coupling unit 400 each may include a fixed block 410 that is fixed to the outside wall 300 and a coupler 420. The fixed blocks 410 face the extensions 210 of the outermost mold units 100. The coupler 420 detachably connects the extension 210 and the fixed block 410 which face each other. It is preferable that the extension 210 and the coupler 420 may be thread-fastened. The length of the coupler 420 may be changed, depending on the coating thickness of the construction structure 1 to be manufactured.

Further, the mold 10 according to an embodiment of the present invention may further include at least one bolt 500 that fixes the fixed block 410 to the outside wall 300 by being thread-fastened to the fixed block 410 through the outside wall 300. Other than combining the outside wall 300 and the mold unit 100, the bolt 500 is used to easily separate the outside wall from the construction structure 1 to be manufactured, after the construction structure 1 is manufactured by means of the mold 10.

As described above, according to the mold 10 of an embodiment of the present invention, since it is possible to cope with the 3D pattern of the hollow structure for the construction structure 1 to be manufactured, by extending the entire shape by systematically combining the mold units 100, it is possible to remarkably reduce the entire construction period by reducing the time taken to prepare frames in the related art. Further, it is possible to provide the base of systematization allowing mass production of the hollow structure for the construction structure 1. Further, when precast concrete elements are used by means of the mold 10 of the present invention, it is possible to largely reduce the necessary cost for the incidental facilities such as necessary equipment.

Hereafter, a method for manufacturing a construction structure according to an embodiment of the present invention is described with reference to the accompanying drawings.

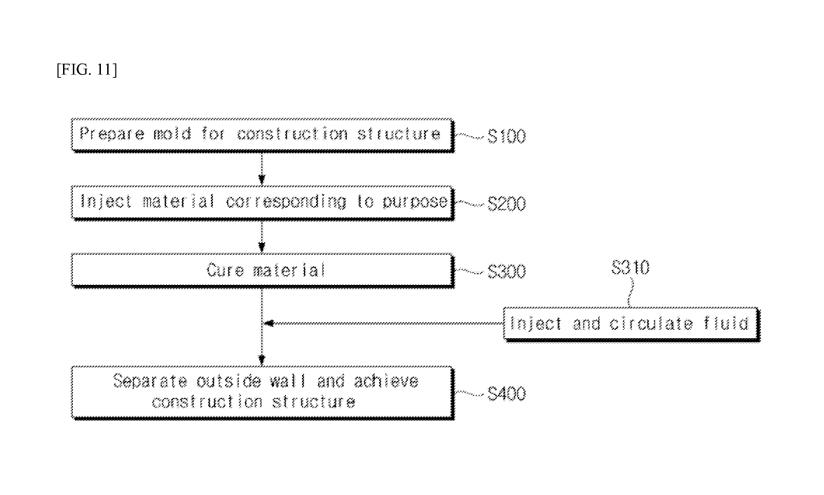

FIG. 11 is a flowchart illustrating a method for manufacturing a construction structure using the mold for a construction structure illustrated in FIG. 1 and FIGS. 12 and 13 are a perspective view and a cross-sectional view of a construction structure manufactured in accordance with the method for manufacturing a construction structure illustrated in FIG. 11. The reference numerals the same as those illustrated in FIGS. 1 to 10 indicate the same components that have the same configuration and operation, thus the repeated description is not provided.

Referring to FIGS. 1 to 13, in order to manufacture a construction structure according to an embodiment of the present invention, the mold 10 having a predetermined 3D pattern is prepared first to cope with the hollow structure for the construction structure 1 to be manufactured (S100). The predetermined 3D pattern may have various shapes, including a hexahedron, and repeated description is not provided.

Next, a fluid material corresponding to the purpose is injected in between mold units 100 of the mold 10 for the construction structure (S200). The fluid material for forming the cell walls of the hollow structure for the construction structure 1 to be manufactured is not limited, as long as it can structurally maintain stress. That is, concrete, ceramics, synthetic resin, and metal can be used. If necessary, the fluid material can be injected by arranging reinforcing members such as a reinforcing bar or a reinforcing fiber.

Next, the material in between the mold units 100 is cured (S300). It may be possible to inject and circulate fluid in the mold units 100 in order to help curing the injected material (S310). It is preferable that the circulating fluid may be heated or cooled to have complementary temperature against the external temperature. For example, it is possible to help the injected material be easily cured, by circulating hot water in the Polar regions (South Pole and North Pole) with very low external temperature and circulating cold water in the desert regions with very high external temperature. Accordingly, it is possible to reduce the entire construction period by reducing the time for curing even under extreme external temperature conditions (North Pole, South Pole, deserts, and the like), and accordingly, it is possible to reduce the manufacturing cost and overcome the extreme curing conditions.

Finally, the construction structure 1 with a plurality of hollow mold units 100 is achieved, as illustrated in FIGS. 12 and 13, by separating the outside wall 300 (S300). In order to separate the outside wall 300, the bolts 500 are loosened so that the outside wall 300 is separated from the construction structure 1. Accordingly, the mold 10 without the outside wall 300 and the bolts 500 is permanently left as a part of the construction structure 1, even after the construction structure 1 is manufactured.

The construction structure 1 manufactured by the method for manufacturing a construction structure 1 of the present invention described above has a structure in which a plurality of hollow cells formed by the mold units 100 is arranged in a 3D pattern. Since the construction structure 1 is hollow, it is possible to decrease the total weight and maintain the rigidity and strength at appropriate levels against the decreased weight. Further, it is possible to limit development of cracks due to the cells arranged in the 3D pattern or damage due to shock to a local part.

On the other hand, functional fluid corresponding to the purpose of the construction structure 1 may be stored or made flow in the hollow construction structure 1 formed by the mold units 100. As the functional fluid, not only water, but liquid or gas containing a functional additive may be used, if necessary. The connecting unit 200 functions as a passage through which the functional fluid is injected or flows. Accordingly, it is preferable that the mold unit 100 and the connecting unit 200 may have sufficient durability and resistance against leakage and thermal and chemical actions to protect the construction structure 1 from the functional fluid.

Although the present invention has been described with reference to the embodiments illustrated in the drawings, those are only examples and may be changed and modified into other equivalent embodiments from the present invention by those skilled in the art. Therefore, the technical protective scope of the present invention should be determined by the scope described in claims.

### INDUSTRIAL APPLICABILITY

The present invention can be used for a construction structure and method of manufacturing the construction structure.

1. A mold for a construction structure, comprising:
a plurality of hollow mold units arranged in a predetermined 3D pattern;
a plurality of connecting units detachably connecting the mold units and communicating the mold units; and
an outside wall fixing and supporting the outermost mold units in the mold units.

2. The mold of claim 1, wherein the mold units have at least one cross-section selected from a group of a circle, an ellipse, and polygon, and a closed shape with curved lines and straight lines.

3. The mold of claim 2, wherein the mold units have a trapezoidal cross-section and are arranged along curved lines in the entire shape.

4. The mold of claim 1, wherein the mold units are made of a soft material having flexibility.

5. The mold of claim 4, wherein the mold units are made of one selected from a group of reinforcing rubber, plastic, and vinyl.

6. The mold of claim 1, wherein the connecting unit each have at least a pair of extensions that communicate with a pair of adjacent mold units and extend outward to face each other, and at least coupler that detachably connects the pair of extensions such that the extensions communicate with each other.

7. The mold of claim 6, wherein the pair of extensions and the coupler are thread-fastened to each other.

8. The mold of claim 6, wherein the coupler has first and second couplers thread-fastened to the pair of extensions, respectively, and a bridge connecting the first and second couplers such that the first and second couplers can rotate.

9. The mold of claim 6, further comprising a plurality of coupling units fixing the outermost mold units to the outside wall.

10. The mold of claim 9, wherein the coupling units each include: a fixed block that is fixed to the outside wall to face the extension of the outermost mold units; and a coupler that detachably combines the extension and the fixed block which face each other.

11. The mold of claim 10, wherein extension and the coupler are thread-fastened to each other.

12. The mold of claim 10, further comprising at least one bolt fixing the fixed block to the outside wall by being thread-fastened to the fixed block through the outside wall.

13. A method for manufacturing a construction structure, comprising:
preparing the mold for a construction structure of claim 1;
injecting a material corresponding to a purpose in between a plurality of mold units in the mold for a construction structure;
curing the material injected in between the mold units; and
achieving a construction structure with a plurality of hollow mold units therein by separating the outside wall.

14. The method of claim 13, wherein the curing of the injected material further includes injecting and circulating fluid in the mold units.

15. The method of claim 14, wherein the circulating fluid is heated or cooled to have complementary temperature against the external temperature.
